(19) United States
(12) Patent Application Publication
(10) Pub. No.: US 2022/0115728 A1
(43) Pub. Date: Apr. 14, 2022

(54) BATTERY PACK ASSEMBLY

(71) Applicant: WINGS EV PRIVATE LIMITED, Indore (IN)

(72) Inventors: Pranav Dandekar, Bengaluru (IN); Prakash Dandekar, Indore (IN)

(21) Appl. No.: 17/498,865

(22) Filed: Oct. 12, 2021

(30) Foreign Application Priority Data
Oct. 12, 2020 (IN) 202021044263

(51) Int. Cl. H01M 50/209; H01M 50/505; H01M 10/647; H01M 10/6554

(52) U.S. Cl. CPC H01M 50/209; H01M 10/6554; H01M 10/647; H01M 50/505

(57) ABSTRACT

A battery pack assembly comprising: prismatic cell placed on one of its edges, to form a battery stack of prismatic cells; a battery pack enclosure; one or more battery stacks, each battery stack being an operative vertical configured stack of a plurality of said prismatic cells, every adjacent pair of cells being separated by a configuration of metal plates and thermal pads, characterised in that, each configured stack comprising one or more repeatable stacks, wherein each repeatable stack comprising at least: a first thermal pad (1); a first prismatic cell (2); a second thermal pad (3); a first metal plate (4); thermals pads (12, 14,13) forming lateral sides of prismatic cells (2).

### RELATED APPLICATIONS

This application claims priority under 35 U.S.C. § 119 to Indian Application 202021044263, filed Oct. 12, 2020, such Indian Application incorporated by reference herein in its entirety.

### FIELD

This invention relates to the field of electronics and electrical engineering. Particularly, this invention relates to a battery pack assembly.

### BACKGROUND

A battery is a device that stores chemical energy and converts it to electrical energy. The chemical reactions in a battery involve the flow of electrons from one material (electrode) to another, through an external circuit. The flow of electrons provides an electric current that can be used to do work.

With the advent and proliferation of hybrid cars and electric vehicles, not only has the demand for these electric batteries shot up, but their requirement to perform safely and efficiently has also gone up.

Batteries are required, and used, across a variety of fields ranging from solar energy to telecommunication to domestic and industrial use. In many applications, the energy density of the battery is an important design criterion. It is desirable to have a small battery that contains a large amount of energy. On the other hand, a battery generates heat during charging and discharging. If this heat is allowed to heat up the battery pack, it degrades the battery components more rapidly resulting in shorter battery life, as measured by the number of charging and discharging cycles. In extreme cases, a heated battery pack can result in thermal runaway, explosion and fire. In the last few years, there have been several well documented instances around the world of electric vehicles catching fire that originated in the battery pack. As a result, preventing the battery pack from heating up excessively is a safety critical issue. A battery pack with high energy density is harder to cool down quickly. As a result, there is a tension between making a high energy density battery pack and making one that dissipates heat efficiently. It is desirable to have both qualities in the same pack: high energy density and efficient heat dissipation.

A common way to dissipate heat generated inside a battery pack is by a method called active/forced cooling in which air or a liquid is circulated inside the battery pack using an external pump and, as a result, the battery pack components stay cool. However, active cooling consumes energy, leaving less available for driving a vehicle.

An alternative category of heat dissipation methods are called passive cooling, where the design of the battery pack makes it easier for heat to be transferred away from the pack without the use of an actively circulated coolant. These methods are not as effective as active cooling methods in dissipating heat, but also do not consume energy the way active cooling methods do.

There is always a need for a battery pack to perform more efficiently than prior art mechanisms and which also has higher heat dissipation capabilities.

### SUMMARY

An object of the invention is to build a battery pack that has higher energy density as well as efficient heat dissipation without the use of active cooling methods.

According to this invention, a battery pack assembly is provided comprising:
a plurality of prismatic cells, each prismatic cell being placed on one of its edges, to form a battery stack of prismatic cells;
a battery pack enclosure configured to define an outer casing of said battery pack assembly and housing said one or more battery stacks of prismatic cells;
one or more battery stacks, each battery stack being an operative vertical configured stack of a plurality of said prismatic cells, every adjacent pair of cells being separated by a configuration of metal plates and thermal pads, characterised in that, each configured stack comprising one or more repeatable stacks, wherein each repeatable stack comprising at least:
   a first thermal pad configured to be stacked just above, and, in physical contact with, a bottom case, of said battery pack enclosure, said first thermal pad forming a lowermost layer of the battery stack;
   a first prismatic cell configured to be stacked just above, and in physical contact with, said first thermal pad;
   a second thermal pad configured to be stacked just above, and in physical contact with, said first prismatic cell;
   a first metal plate configured to be stacked just above, and in physical contact with, said second thermal pad;
a seventh side thermal pad adjacent to, and in contact with, a first lateral side of said one or more prismatic cells;
an eighth side thermal pad adjacent to, and in contact with, a second lateral side of said one or more prismatic cells; and
a ninth side thermal pad is adjacent to, and in contact with, a rear side of said one or more prismatic cells.

In at least an embodiment, the battery pack assembly comprises:
a third thermal pad is configured to be stacked just above, and in physical contact with, said first metal plate;
a second prismatic cell is configured to be stacked just above, and in physical contact with, said third thermal pad;
a fourth thermal pad is configured to be stacked just above, and in physical contact with, said second prismatic cell;
a second metal plate is configured to be stacked just above, and in physical contact with, said fourth thermal pad;
a fifth thermal pad is configured to be stacked just above, and in physical contact with, said second metal plate;
a third prismatic cell is configured to be stacked just above, and in physical contact with, said fifth thermal pad;
a sixth thermal pad is configured to be stacked just above, and in physical contact with, said third prismatic cell;
a seventh side thermal pad adjacent to, and in contact with, a first lateral side of said laid-down prismatic cells;
an eighth side thermal pad adjacent to, and in contact with, a second lateral side of said laid-down prismatic cells; and
a ninth side thermal pad is adjacent to, and in contact with, a rear side of said laid-down prismatic cells.

In at least an embodiment, said plurality of prismatic cells are connected in a configuration selected from a group of configurations consisting of series configuration, parallel configuration, and a series-parallel combinatorial configuration.

In at least an embodiment,
said battery pack assembly being configured with a top cover, a bottom case, and side walls which define a battery pack enclosure; and
said battery pack enclosure having a plurality of vertical metallic partitions which define its side walls.

In at least an embodiment, each of the laid down prismatic cells have at least three of its lateral sides in physical contact with a thermal pad which, in turn, is in contact with walls/sides of said enclosure and also has its dorsal and ventral sides in physical contact with a thermal pad, thereby providing thermal pad contact on at least five of the six sides of each cell.

In at least an embodiment, said battery pack enclosure comprises a top cover configured to be located/stacked just above, and in physical contact with, said sixth thermal pad.

In at least an embodiment, five surfaces, of the six surfaces, of each cell, are directly in contact with at least a thermal pad which, in turn, is in contact with at least a wall/side of said battery pack enclosure that defines boundaries of said battery pack assembly.

In at least an embodiment, each configured stack is laterally spaced apart from an adjacent configured stack with a metal partition, therebetween.

In at least an embodiment, a first set of configured stacks, on one side of said battery pack assembly is spaced apart from a second set of configured stacks, on another side of said battery pack assembly, with a medial gap, between the first set and the second step.

In at least an embodiment, a first set of configured stacks, on one side of said battery pack assembly is spaced apart from a second set of configured stacks, on another side of said battery pack assembly, with a medial gap, between the first set and the second step, in that, a first bus bar is located at a medial gap side of each of the cells, communicably coupled to a set of cells, in order to ensure that the cells are connected.

In at least an embodiment, a first set of configured stacks, on one side of said battery pack assembly is spaced apart from a second set of configured stacks, on another side of said battery pack assembly, with a medial gap, between the first set and the second step, in that, a battery management system (BMS) is located, centrally, in said medial gap—thereby, equalizing the length of wires from each of said cells to said battery management system and, therefore, minimizing variance in length of wires to each of said cells.

In at least an embodiment, the thermal pads can be thermal paste or thermal grease.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The invention will now be described in relation to the accompanying drawings, in which:

FIG. 1 illustrates an exploded view of a battery stack, of a battery pack assembly, of this invention;

FIG. 2 illustrates a bottom case, of the battery pack assembly, having the battery packs next to each other;

FIG. 3a illustrates a thermal profile of the battery pack assembly, of this invention, having thermal pads;

FIG. 3b illustrates a thermal profile of the battery pack assembly without thermal pads;

FIG. 4a illustrates a thermal profile of the battery pack assembly's bottom case, with battery setup of this invention, having thermal pads;

FIG. 4b illustrates a thermal profile of the battery pack assembly's bottom case with battery setup, without thermal pads;

FIG. 5a illustrates a thermal profile, in isometric view, of the battery pack assembly's bottom case with battery setup, of this invention, having thermal pads; and

FIG. 5b illustrates a thermal profile, in isometric view, of the battery pack assembly's bottom case with battery setup, without thermal pads

### DETAILED DESCRIPTION

According to this invention, a battery pack assembly is provided.

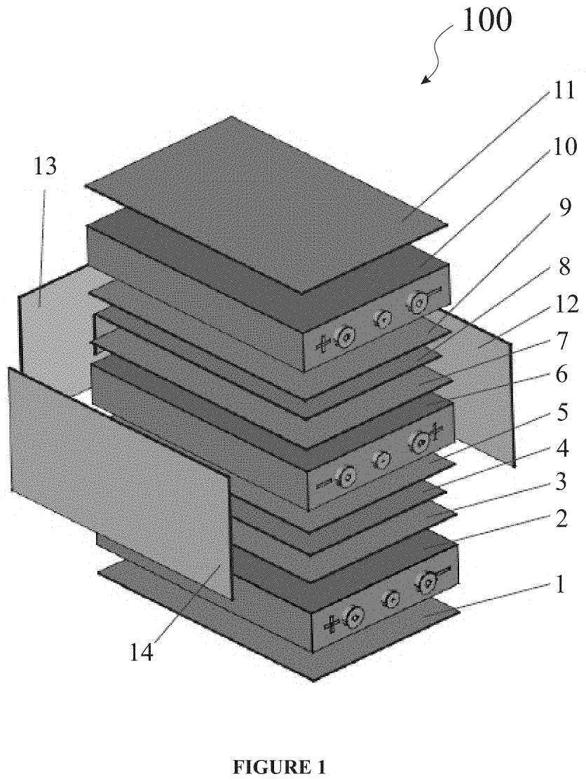

FIG. 1 illustrates an exploded view of a battery stack, of a battery pack assembly, of this invention.

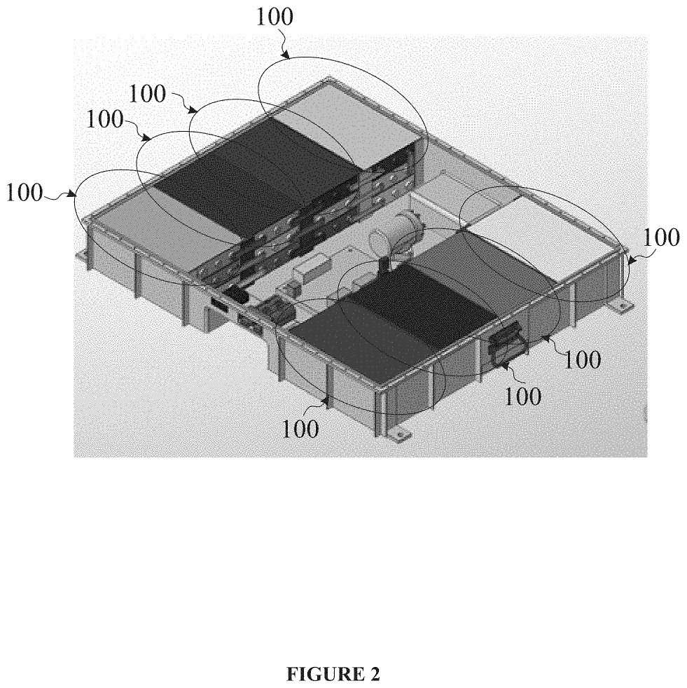

FIG. 2 illustrates a bottom case, of the battery pack assembly, having the battery packs next to each other.

In at least an embodiment, the battery pack assembly comprises a plurality of prismatic cells, in series with respect to each other. Prior art cylindrical cells are cylindrical in shape and use up more space. Prismatic cells, used by this invention, are cuboidal/rectangular and, therefore, conserve space, thereby increasing the energy density of the battery pack.

According to a non-limiting exemplary embodiment, a battery pack is built using 24 prismatic Lithium Ferrous Phosphate (LFP) cells in series, each cell of 60 Ah. Each LFP cell has a voltage of 3.2V. So 24 such LFP cells in series result in a battery pack of 76.8V 60 Ah (3.2×24=76.8V). Prior art cylindrical cells are typically much smaller capacity (e.g., 5 Ah, 6 Ah). So, in order to build a battery pack using prior art cylindrical cells (say 3.2V 5 Ah), using 24 such prior art cylindrical cells, connected in series, only gives 76.8V 5 Ah. Therefore according to prior art usage of cylindrical cells, a prior art battery pack assembly would need 12 such “chains” in parallel to get 72V 60 Ah. Therefore, using larger prismatic cells enables this invention's battery pack to have only one chain of 24 cells in series, instead of having a large number of them (e.g. 12 in the preceding example). Having fewer parallel chains is better because it is more resilient against variation in internal cell resistances and cell voltages over time.

Prior art prismatic cells are placed vertically (with their terminals at the top). In at least a preferred embodiment, the cells have a thickness of 30 mm whereas the height is 217 mm. Placing the cells vertically results in a very tall battery pack (i.e. with a height greater than 217 mm), which cannot be easily fit into certain vehicles. In at least an embodiment, each prismatic cell is placed on its height-wise edge. A stack of such height-wise laid-down prismatic cells, when used, lower the height of the battery pack substantially.

This compact vertical stacking of height-wise laid down prismatic cells along with the mechanisms to efficiently dissipate heat is a central aspect of this invention.

In at least an embodiment, a battery pack assembly is configured with a top cover, a bottom case, and side walls which define the battery pack enclosure. The battery pack enclosure has a plurality of vertical metallic partitions which define its side walls. In at least an embodiment, the top cover and the bottom case are also metallic. Each partition holds a battery stack (100), as defined by this invention, being a vertical stack of a plurality of height-wise laid down prismatic cells, where every vertically adjacent pair of cells is separated by a metal plate and thermal pads. Thermal pads increase the contact surface area between two surfaces from about 2-4% to nearly 100%. Moreover, thermal pads are thermally conductive but electrically insulated. As a result, they enable significantly faster transfer of heat between two surfaces that are at different temperatures. Thermal pads will not be as effective with cylindrical cells; they are far more suitable for use with prismatic cells because of their cuboidal shape.

In at least an embodiment of the battery stack (100), a first thermal pad (1) is configured to be located/stacked just above, and in physical contact with, a bottom case. This first thermal pad (1) is the lowermost layer of the battery stack (100).

In at least an embodiment of the battery stack (100), a first (height-wise) laid-down prismatic cell (2) is configured to be located/stacked just above, and in physical contact with, the first thermal pad (1). Each cell, per se, has at least three of its lateral sides in physical contact with a thermal pad which, in turn, is in contact with walls/sides of the enclosure and also has its dorsal and ventral sides in physical contact with a thermal pad. Thus, there is thermal pad contact on at least five of the six sides of each cell.

In at least an embodiment of the battery stack (100), a second thermal pad (3) is configured to be located/stacked just above, and in physical contact with, the first height-wise laid-down prismatic cell (2).

In at least an embodiment of the battery stack (100), a first metal plate (4) is configured to be located/stacked just above, and in physical contact with, the second thermal pad (3).

In at least an embodiment of the battery stack (100), a third thermal pad (5) is configured to be located/stacked just above, and in physical contact with, the first metal plate (4).

In at least an embodiment of the battery stack (100), a second (height-wise) laid-down prismatic cell (6) is configured to be located/stacked just above, and in physical contact with, the third thermal pad (5). Each cell, per se, has at least three of its lateral sides in physical contact with a thermal pad which, in turn, is in contact with walls/sides of the enclosure and also has its dorsal and ventral sides in physical contact with a thermal pad. Thus, there is thermal pad contact on at least five of the six sides of each cell.

In at least an embodiment of the battery stack (100), a fourth thermal pad (7) is configured to be located/stacked just above, and in physical contact with, the second height-wise laid-down prismatic cell (6).

In at least an embodiment of the battery stack (100), a second metal plate (8) is configured to be located/stacked just above, and in physical contact with, the fourth thermal pad (7).

In at least an embodiment of the battery stack (100), a fifth thermal pad (9) is configured to be located/stacked just above, and in physical contact with, the second metal plate (8).

In at least an embodiment of the battery stack (100), a third (height-wise) laid-down prismatic cell (10) is configured to be located/stacked just above, and in physical contact with, the fifth thermal pad (9). Each cell, per se, has at least three of its lateral sides in physical contact with a thermal pad which, in turn, is in contact with walls/sides of the enclosure and also has its dorsal and ventral sides in physical contact with a thermal pad. Thus, there is thermal pad contact on at least five of the six sides of each cell.

In at least an embodiment of the battery stack (100), a sixth thermal pad (11) is configured to be located/stacked just above, and in physical contact with, the third height-wise laid-down prismatic cell (10).

In at least an embodiment of the battery stack (100), a seventh side thermal pad (12) is provided adjacent to, and in contact with, a first lateral side of the laid-down prismatic cells (2, 6, 10).

In at least an embodiment of the battery stack (100), an eighth side thermal pad (14) is provided adjacent to, and in contact with, a second lateral side of the laid-down prismatic cells (2, 6, 10).

In at least an embodiment of the battery stack (100), a ninth side thermal pad (13) is provided adjacent to, and in contact with, a rear side of the laid-down prismatic cells (2, 6, 10).

In at least an embodiment, a top cover is configured to be located/stacked just above, and in physical contact with, the sixth thermal pad (11).

Thus, each configured stack can be defined as a multi-layered stack having the following configuration from an operative bottom to an operative top:

a first thermal pad (1);

a first height-wise laid-down prismatic cell (2);

a second thermal pad (3);

a first metal plate (4);

a third thermal pad (5);

a second height-wise laid-down prismatic cell (6);

a fourth thermal pad (7);

a second metal plate (8);

a fifth thermal pad (9);

a third height-wise laid-down prismatic cell (10);

a sixth thermal pad (11);

a seventh side thermal pad (12);an eighth side thermal pad (14); and

a ninth rear thermal pad (13).

This multi-layered stack, having this pre-defined sequence of stack configuration, allows heat to be efficiently dissipated from the cell to the enclosure via the thermal pads and metal plates. In simulations, this has shown to be very effective as opposed to not using thermal pads. Without thermal pads, only 2-4% of the cell surface is in physical contact with the metal plates/walls surrounding the cell; the rest of the contact area is air. This is due to the microscopic irregularities even on surfaces that appear smooth. Using thermal pads between cells and enclosing metal plates and/or walls, as disclosed in this specification, increases the physical contact area between the cell and the enclosure from 2-4% to nearly 100%. This improves heat dissipation from the cell to the battery pack enclosure by a factor of 25×. It can be seen that every cell first interfaces with a thermal pad which then interfaces with a metal; this thermal padding improves thermal conductivity drastically. These thermal pads are thermally conductive but electrically insulating. It has been observed that, owing to the configuration of this invention, there is close to 100% contact of each side of a cell to the thermal pad first. Basically, each cell is ensconced by thermal pads; thereby, drastically improving heat dissipation from the cells.

Thus, five of the six surfaces of a cell (i.e. the first cell, the second cell, and the third cell) is directly in contact with at least a thermal pad which, in turn, is in contact with at least a wall/side of the enclosure that defines the boundaries of the battery pack. This ensures relatively faster heat dissipation. These pads also provide cushioning against vibrations so that shocks/vibrations are dampened before they reach the ensconced cells.

This stacking configuration ensures that there are no cells in the interior of the enclosure—or, in other words, there are no cells that are not in physical contact with at least a wall/side of the enclosure that defines the boundaries of the battery pack.

In at least an embodiment of this invention, as shown in FIG. 2, of the accompanying drawings, for a given battery pack assembly, a first configured stack (100) is laterally spaced apart from a second configured stack (100) with a metal plate defining a partition between two laterally adjacent stacks. A first set of such laterally adjacent stacks are provided on one side of a battery pack assembly and a second set of such laterally adjacent stacks are provided on another side of a battery pack assembly with a medial gap, therebetween, where metal partitions are defined. The medial gap is the only gap where the cells, of each stack, are either not in physical contact with a thermal pad or with a wall/side of the enclosure.

In at least an embodiment, a first bus bar (14) is located at a medial gap side of each of the cells, communicably coupled to a set of cells, in order to ensure that the cells are connected in series (as opposed to many chains in parallel). Particularly, this bus bar is a copper bus bar—it obviates the need for welding which can be expensive.

In at least an embodiment, a battery management system (BMS) is located, centrally, in this medial gap—thereby, equalizing the length of wires from each of the cells to the battery management system and, therefore, minimizing the variance in length of wires to each of the cells.

This configuration prevents cells from sliding/moving during operations/movement of the battery pack (especially considering its usage in vehicles).

In at least an embodiment, the thermal pad is interchangeable with thermal paste or thermal grease in the battery pack assembly of this invention.

It is to be understood, that vertically, stacking, as described above, is non-limiting in nature, in that, the stacking in the above-mentioned form and the battery pack assembly can go on increasing in height as per requirement.

It is to be understood, that horizontally, the number of stacks, as described above, is non-limiting in nature, in that, the number of stacks may be increased in the above-mentioned form and the battery pack assembly can go on expanding in length/width as per requirement.

According to a non-limiting exemplary embodiment, the battery pack assembly of this invention was subjected to simulation-based thermal analysis

In at least a first non-limiting exemplary embodiment, the thermal analysis was performed on the battery pack of this invention with and without thermal pads, for an ambient temperature of 40° C. as its body initial temperature. A temperature profile was applied to each cell in the battery pack to simulate the effect of heat generated inside the cell while the battery pack is being discharged.

The following material properties were used:

Aluminium

Thermal Conductivity=205 W/m C

Density=2.7 g/cm3

Specific heat=900 J/kg. C

Brass

Thermal Conductivity=109 W/m C

Density=8.73 g/cm3

Specific heat=380 J/kg. C

Thermal Pad

Thermal Conductivity=1 W/m C

Density=1.12 g/cm3

Specific heat=711 J/kg. C

Initial Temperature of whole body, of battery pack assembly, was considered as 40° C.

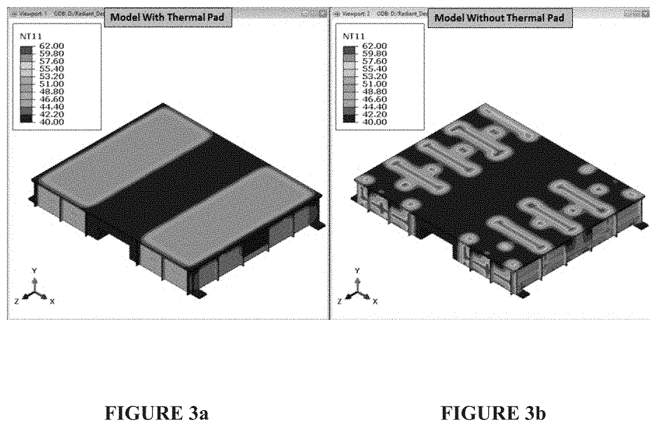

FIG. 3a illustrates a thermal profile of the battery pack assembly, of this invention, having thermal pads.

FIG. 3b illustrates a thermal profile of the battery pack assembly without thermal pads.

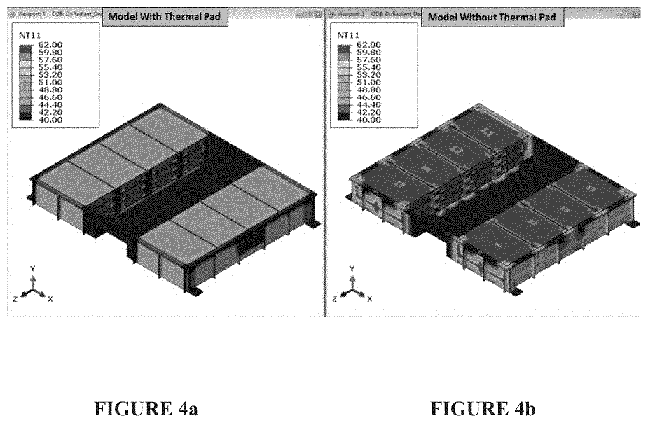

FIG. 4a illustrates a thermal profile of the battery pack assembly's bottom case, with battery setup of this invention, having thermal pads.

FIG. 4b illustrates a thermal profile of the battery pack assembly's bottom case, with battery setup, without thermal pads.

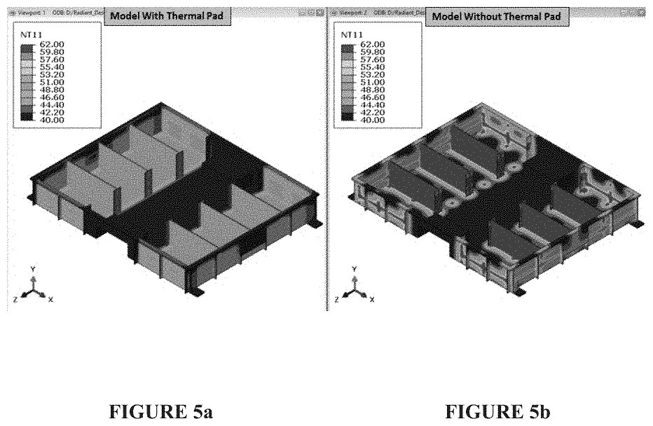

FIG. 5a illustrates a thermal profile, in isometric view, of the battery pack assembly's bottom case with battery setup, of this invention, having thermal pads.

FIG. 5b illustrates a thermal profile, in isometric view, of the battery pack assembly's bottom case with battery setup, without thermal pads.

Transient analysis was performed and temperature distribution of each component was observed after 3600 seconds of applying the temperature profile. The temperature distribution for the battery pack assembly of this invention with and without thermal pads was analyzed.

From the tests, and from the figures, it can be inferred that there is significantly improved cooling, by way of heat dissipation, due to the nature of location of the thermal pads in accordance with this invention; this helps to keep the battery pack components including cells, significantly cooler.

The TECHNICAL ADVANCEMENT of this invention lies in providing a battery pack assembly configured to obviate problems related to height, heat dissipation, efficiency, movement; all by providing a carefully designed, experiment-proved configuration of cells, associated thermal pads, associated bus bars, and associated battery management system. Prior art battery assemblies either require active cooling or do not dissipate heat as effectively, which results in poorer battery performance over time. The current invention's configuration eliminates the requirement of active (external) cooling, which makes the assembly compact and additionally saves energy and cost (spent on the active cooling system).

While this detailed description has disclosed certain specific embodiments for illustrative purposes, various modifications will be apparent to those skilled in the art which do not constitute departures from the spirit and scope of the invention as defined in the following claims, and it is to be distinctly understood that the foregoing descriptive matter is to be interpreted merely as illustrative of the invention and not as a limitation.

1. A battery pack assembly comprising:
a plurality of prismatic cells, each prismatic cell being placed on one of its edges, to form a battery stack of prismatic cells;
a battery pack enclosure configured to define an outer casing of said battery pack assembly and housing said one or more battery stacks of prismatic cells;
one or more battery stacks, each battery stack being an operative vertical configured stack of a plurality of said prismatic cells, every adjacent pair of cells being separated by a configuration of metal plates and thermal pads, characterised in that, each configured stack comprising one or more repeatable stacks, wherein each repeatable stack comprising at least:
a first thermal pad (1) configured to be stacked just above, and, in physical contact with, a bottom case, of said battery pack enclosure, said first thermal pad (1) forming a lowermost layer of the battery stack (100);
a first prismatic cell (2) configured to be stacked just above, and in physical contact with, said first thermal pad (1);
a second thermal pad (3) configured to be stacked just above, and in physical contact with, said first prismatic cell (2);
a first metal plate (4) configured to be stacked just above, and in physical contact with, said second thermal pad (3);
a seventh side thermal pad (12) adjacent to, and in contact with, a first lateral side of said one or more prismatic cells (2);
an eighth side thermal pad (14) adjacent to, and in contact with, a second lateral side of said one or more prismatic cells (2); and
a ninth side thermal pad (13) is adjacent to, and in contact with, a rear side of said one or more prismatic cells (2).

2. The battery pack assembly as claimed in claim 1 wherein,
a third thermal pad (5) is configured to be stacked just above, and in physical contact with, said first metal plate (4);
a second prismatic cell (6) is configured to be stacked just above, and in physical contact with, said third thermal pad (5);
a fourth thermal pad (7) is configured to be stacked just above, and in physical contact with, said second prismatic cell (6);
a second metal plate (8) is configured to be stacked just above, and in physical contact with, said fourth thermal pad (7);
a fifth thermal pad (9) is configured to be stacked just above, and in physical contact with, said second metal plate (8);
a third prismatic cell (10) is configured to be stacked just above, and in physical contact with, said fifth thermal pad (9);
a sixth thermal pad (11) is configured to be stacked just above, and in physical contact with, said third prismatic cell (10);
a seventh side thermal pad (12) adjacent to, and in contact with, a first lateral side of said laid-down prismatic cells (2, 6, 10);
an eighth side thermal pad (14) adjacent to, and in contact with, a second lateral side of said laid-down prismatic cells (2, 6, 10); and
a ninth side thermal pad (13) is adjacent to, and in contact with, a rear side of said laid-down prismatic cells (2, 6, 10).

3. The battery pack assembly as claimed in claim 1 wherein, said plurality of prismatic cells being connected in a configuration selected from a group of configurations consisting of series configuration, parallel configuration, and a series-parallel combinatorial configuration.

4. The battery pack assembly as claimed in claim 1 wherein,
said battery pack assembly being configured with a top cover, a bottom case, and side walls which define a battery pack enclosure; and
said battery pack enclosure having a plurality of vertical metallic partitions which define its side walls.

5. The battery pack assembly as claimed in claim 1 wherein, each of the laid down prismatic cells having at least three of its lateral sides in physical contact with a thermal pad which, in turn, is in contact with walls/sides of said enclosure and also has its dorsal and ventral sides in physical contact with a thermal pad, thereby providing thermal pad contact on at least five of the six sides of each cell.

6. The battery pack assembly as claimed in claim 1 wherein, said battery pack enclosure comprising a top cover configured to be located/stacked just above, and in physical contact with, said sixth thermal pad (11).

7. The battery pack assembly as claimed in claim 1 wherein, five surfaces, of the six surfaces of each cell (2, 6, 10), are directly in contact with at least a thermal pad which, in turn, is in contact with at least a wall/side of said battery pack enclosure that defines boundaries of said battery pack assembly.

8. The battery pack assembly as claimed in claim 1 wherein, each configured stack is laterally spaced apart from an adjacent configured stack with a metal partition, therebetween.

9. The battery pack assembly as claimed in claim 1 wherein, a first set of configured stacks, on one side of said battery pack assembly is spaced apart from a second set of configured stacks, on another side of said battery pack assembly, with a medial gap, between the first set and the second step.

10. The battery pack assembly as claimed in claim 1 wherein, a first set of configured stacks, on one side of said battery pack assembly is spaced apart from a second set of configured stacks, on another side of said battery pack assembly, with a medial gap, between the first set and the second step, in that, a first bus bar (14) is located at a medial gap side of each of the cells, communicably coupled to a set of cells, in order to ensure that the cells are connected.

11. The battery pack assembly as claimed in claim 1 wherein, a first set of configured stacks, on one side of said battery pack assembly is spaced apart from a second set of configured stacks, on another side of said battery pack assembly, with a medial gap, between the first set and the second step, in that, a battery management system (BMS) is located, centrally, in said medial gap—thereby, equalizing the length of wires from each of said cells to said battery management system and, therefore, minimizing variance in length of wires to each of said cells.

12. The battery pack assembly as claimed in claim 1 wherein, each of the thermal pads being thermal paste or thermal grease.
